(19) United States
(12) Patent Application Publication
(10) Pub. No.: US 2021/0379550 A1
(43) Pub. Date: Dec. 9, 2021

(54) WATER INJECTION METHOD FOR PID CONTROL-BASED ADAPTIVE INTELLIGENT WATER INJECTION SYSTEM

(71) Applicant: ZHEJIANG SCI-TECH UNIVERSITY, Hangzhou (CN)

(72) Inventors: Haozhe JIN, Hangzhou (CN); Guofu OU, Hangzhou (CN); Zhichao FAN, Hangzhou (CN); Yong GU, Hangzhou (CN); Qun WANG, Hangzhou (CN); Chao WANG, Hangzhou (CN)

(73) Assignee: ZHEJIANG SCI-TECH UNIVERSITY, Hangzhou (CN)

(21) Appl. No.: 17/286,825

(22) PCT Filed: Apr. 20, 2020
(86) PCT No.: PCT/CN2020/085686

§ 371 Date: Apr. 20, 2021

(30) Foreign Application Priority Data
Mar. 19, 2019 (CN) 201910207326.4

(51) Int. Cl. B01J 19/00; G06F 17/18; B01J 8/04

(52) U.S. Cl. CPC B01J 19/0013; G06F 17/18; B01J 2208/00176; B01J 2219/00006; B01J 8/04

(57) ABSTRACT

A water injection method for a PID control-based adaptive intelligent water injection system is provided. The system includes a water injection portion, a power portion, a control portion, and a measurement and transmission portion. The water injection portion includes a hydrogenation reactor, heat exchangers, air coolers, and a separation tank. The power portion includes a motor and a water pump. The control portion includes a console and a bus. Temperature, pressure and flow velocity transmitters are additionally arranged at each of inlet and outlet pipes of various heat exchangers, and water injection points are disposed. Temperature, pressure and flow velocity signals of the inlet and outlet pipes of heat exchange devices are monitored, and the console performs error analysis on the three signals and uses a PID control algorithm to control the adjustment valve to alter the valve opening degree to adjust the water injection amount in real time.

### CROSS REFERENCE TO THE RELATED APPLICATIONS

This application is the national phase entry of International Application No. PCT/CN2020/085686, filed on Apr. 20, 2020, which is based upon and claims priority to Chinese Patent Application No. 201910207326.4, filed on Mar. 19, 2019, the entire contents of which are incorporated herein by reference.

### TECHNICAL FIELD

The present invention relates to a heat exchanger water injection system and a water injection method in petrochemical industry, and more particularly, to a water injection method for a proportional-integral-differential (PID) control-based adaptive intelligent water injection system.

### BACKGROUND

In regard to heat exchange devices, heat exchangers and air coolers are widely used in metallurgy, oil refining, chemical industry and other industries. However, as the inferior quality of the crude oil to be processed, the content of S, N, Cl and other corrosive media in hydrogenation feedstock increases, which aggravates the risk of corrosion of the hydrogenation apparatuses. Among them, the corrosion of ammonium salt is particularly serious. At present, most petrochemical enterprises in China alleviate the risk of corrosion of the ammonium salt by the water injection method, which has achieved certain effects. Nevertheless, the traditional water injection method has the following shortcomings. (1) Ammonium salt corrosion exists in real time, while traditional intermittent water injection is periodic with water injection once in a certain amount of time and m tons each time. The water injection amount cannot be adjusted in real time according to the amount of crystallized ammonium salt to cause the lag, which makes it difficult to deal with emergencies, such as that the amount of crystallized ammonium salt suddenly increases greatly. The intermittent water injection method is required to thoroughly clean the ammonium salt in the heat exchange device and pipelines without leaving any residual, otherwise it may cause serious corrosion to downstream pipes and devices. (2) Nowadays, with the increasingly strict environmental protection policies in China, higher requirements have been put forward for the utilization of water resources in enterprises. Traditional continuous water injection wastes water resources to some extent, which violates the enterprise philosophy of energy conservation and emission reduction. Based on the above, with respect to the shortcomings of the traditional water injection method, it is highly desirable for enterprises to develop a new intelligent water injection method that can adjust the water injection amount in real time and maximize saving water resources, to improve the adaptability of heat exchange devices under complex working conditions and ensure the safe and stable operation of the apparatuses for a long period of time. Therefore, during the design of a hydrogenation apparatus, full attention must be paid to the design of a reaction effluent water injection system, especially during the design of a new apparatus or the transformation of an old apparatus, it is more necessary to develop a water injection system suitable for the hydrogenation apparatus.

### SUMMARY

With respect to prominent problems such as lag and resource waste in the traditional water injection method in petrochemical processes, an objective of the present invention is to provide a PID control-based adaptive intelligent water injection system and a water injection method. In the case of making full use of water resources, the present invention adjusts the water injection amount in real time with respect to a crystallization rate of ammonium salt in heat exchange devices and surrounding pipes, thereby alleviating the corrosion of ammonium salt on the devices in time, ensuring the smooth operation of the devices and avoiding flow corrosion failures caused by a sudden increase in the concentration of a corrosive medium.

In order to solve the above objective, the present invention adopts the following technical solutions.

I. PID Control-Based Adaptive Intelligent Water Injection System

The present invention includes a water injection portion, a power portion, a control portion, and a measurement and transmission portion. The water injection portion includes a hydrogenation reactor, N shell-and-tube heat exchangers, air coolers, and a separation tank. A hydrogenation reaction effluent at a bottom of the hydrogenation reactor is connected to inlets of the air coolers via the N shell-and-tube heat exchangers. Hydrogenation reaction effluent is cooled by a plurality of parallel air coolers, and then is connected to an inlet located on a side surface of the separation tank through an outlet manifold of the air coolers. The hydrogenation reaction effluent is separated into three phases by the separation tank, wherein a gas phase flows out of a top of the separation tank, an oil phase flows out of the side surface of the separation tank corresponding to the inlet, and an acidic aqueous phase flows out of a bottom of the separation tank. N−1 pipelines are separately led out from pipes between the N shell-and-tube heat exchangers, one pipeline is led out from the inlet pipe of the first heat exchanger, and one pipeline is led out from a pipe between the last heat exchanger and the air coolers, and a total of N+1 pipelines constitute parallel pipes. Branches of parallel pipes are throttled by N+1 adjustment valves of an identical specification, respectively, and then are gathered to a straight pipe to connect to the power portion. A temperature transmitter, a pressure transmitter, and a flow velocity transmitter are connected to each of the shell-and-tube heat exchangers to jointly form the measurement and transmission portion. Signals of the three transmitters are connected to the control portion to control an opening degree required by each adjustment valve.

The power portion includes a motor and a water pump. The motor drives the water pump to rotate, and the outlet of the water pump is connected to the inlet of the straight pipe.

The control portion includes a console and an RS485 bus. The signals of the three transmitters are transmitted to the console through the RS485 bus to control the opening degree required by each adjustment valve through a PID control algorithm.

The N shell-and-tube heat exchangers are set according to an actual requirement of an industrial site.

II. A water injection method based on the adaptive intelligent water injection system mentioned above includes the following steps:

step 1): after a stable operation of the system, enabling the hydrogenation reaction effluent to successively pass through the N heat exchangers and the plurality of parallel air coolers from the bottom of the hydrogenation reactor and then to enter the separation tank;

step 2): arranging the temperature transmitter, the pressure transmitter, and the flow velocity transmitter at each of the inlet and the outlet of each of the N heat exchangers connected in series, wherein a total number of each of the three transmitters is N+1; detecting and transmitting, by the three transmitters, a temperature signal Tᵢ, a pressure signal Pᵢ, and a flow velocity signal Vᵢ to the console through the RS485 bus, respectively, wherein a value range of i is i∈[1, N+1];

step 3): receiving, by the console, the temperature signal Tᵢ, the pressure signal Pᵢ and the flow velocity signal Vᵢ, and then performing screening analysis as follows on the signals:

under a normal working condition, a temperature difference between two ends of the heat exchanger or the air coolers basically remains constant, that is, no salt coagulation occurs in the heat exchanger; therefore, a relative error of temperature values of two adjacent heat exchangers are not directly calculated. The following calculation method is employed: at a moment t and a moment t+1, temperature differences detected by any two adjacent temperature transmitters are ΔT₍ᵢ₎(t) and ΔT₍ᵢ₎(t+1), respectively, wherein

ΔT₍ᵢ₎(t)=|Tᵢ₊₁(t)−T₍ᵢ₎(t)|

ΔT₍ᵢ₎(t+1)=|T₍ᵢ₊₁₎(t+1)−T₍ᵢ₎(t+1)|,

where, signals monitored by the i^{th} temperature transmitter and the i+1^{th} temperature transmitter at the moment t are T₍ᵢ₎(t) and T₍ᵢ₊₁₎(t), respectively; similarly, signals monitored by the i^{th} temperature transmitter and the i+1^{th} temperature transmitter at the moment t+1 are T₍ᵢ₎(t+1) and T₍ᵢ₊₁₎(t+1), respectively.

Then, a temperature signal relative error between two adjacent temperature transmitters is e_{T(i)}:

$${e}_{T ( i )} = \frac{\vert Δ {T}_{( i )} ( t + 1 ) - Δ {T}_{( i )} ( t ) \vert}{Δ {T}_{( i )} ( t )} \times 100 \% .$$

A pressure signal relative error between any two adjacent pressure transmitters is e_{P(i)}:

$${e}_{P ( i )} = \frac{\vert {P}_{i + 1} - {P}_{i} \vert}{{P}_{i}} \times 100 \% .$$

Similarly, a flow velocity signal relative error between any two adjacent flow velocity transmitters is e_{V(i)}:

$${e}_{V ( i )} = \frac{\vert {V}_{i + 1} - {V}_{i} \vert}{{V}_{i}} \times 100 \% ;$$

assuming that a relative error e_{X(i)} follows a Gaussian distribution E-N(μ, σ²), where X takes a pressure P, a temperature T or a flow velocity V, then a probability density function of the relative error e_{X(i)} is:

$$p ( E ) = \frac{1}{\sqrt{2 π} σ} exp ( \frac{- {( {e}_{X ( i )} - μ )}^{2}}{2 {σ}^{2}} ) ,$$

where μ is an overall expectation, and σ² is a population variance;
μ and σ² in a population are predicted according to an existing relative error e_{X(i)}, and a calculation method is as follows:

$$μ = \frac{1}{N} {\sum }_{i = 1}^{N} {e}_{X ( i )} , \\ {σ}^{2} = \frac{1}{N} {\sum }_{i = 1}^{N} {( {e}_{X ( i )} - μ )}^{2} ;$$

step 4): according to a principle of 3σ that a probability of e_{X(i)} falling outside (μ−3σ, μ+3σ) is less than 3‰, taking an interval (μ−3σ, μ+3σ) as an actual possible value interval of the relative error e_{X(i)}, taking data outside the value interval as outlier data, and removing the outlier data; if there is no outlier data, going directly to step 5); otherwise, screening out outlier data points to be Tₖ, Pₖ, and Vₖ, where k∈[1, N+1], and then are checking and replacing the k^{th} temperature transmitter, k^{th} pressure transmitter and k^{th} flow velocity transmitter in time;

step 5): calculating an average value e̅_̅{̅X̅(̅i̅)̅}̅ of the three relative errors e_{T(i)}, e_{P(i)}, and e_{V(i)} at any position as follows:

$$\overline{{e}_{X ( i )}} = \frac{\vert {e}_{T ( i )} + {e}_{P ( i )} + {e}_{V ( i )} \vert}{3} \times 100 \% ,$$

wherein, if e̅_̅{̅X̅(̅i̅)̅}̅≤1%, then no salt coagulation and blockage occurs in an i^{th} heat exchanger and an inlet pipe and an outlet pipe of the 1^{th} heat exchanger;
if 1%<e̅_̅{̅X̅(̅i̅)̅}̅<2%, then slight salt coagulation occurs in the i^{th} heat exchanger and the inlet pipe and the outlet pipe of the i^{th} heat exchanger, but it is unnecessary to take measures; and

if e̅_̅{̅X̅(̅i̅)̅}̅≥2%, then it is considered that salt coagulation occurs in the i^{th} heat exchanger and the inlet pipe and the outlet pipe of the i^{th} heat exchanger, and the console is required to issue an instruction to a Q^{th} adjustment valve, Q∈[1, N], to enable the Q^{th} adjustment valve to adjust a valve opening degree in real time;

step 6): employing, by the console, the PID control algorithm including a proportional (P) control parameter, an integral (I) control parameter and a differential (D) control parameter; taking the average error e̅_̅{̅X̅(̅i̅)̅}̅ as an input of the whole control system, and taking a difference e(t) between the average error e̅_̅{̅X̅(̅i̅)̅}̅ and a set value e₀ as an input of a controller; wherein e₀=2%; and taking an opening degree of the adjustment valve at the moment t as an output uᵢ(t) of the controller, wherein the output uᵢ(t) is expressed by the following formula:

$${u}_{i} ( t ) = {K}_{p} e ( t ) + {T}_{0} {K}_{i} {\sum }_{j = 0}^{t} e ( j ) + \frac{1}{{T}_{0}} {K}_{d} ( e ( t ) - e ( t - 1 ) ) ,$$

where Kₚ, Kᵢ, and K_{d} represent a proportional coefficient, an integral time constant, and a differential time constant, respectively, and T₀ is a sampling cycle of each transmitter; adjusting and controlling the system to meet predetermined requirements;

step 7): in step 5), if e̅_̅{̅X̅(̅i̅)̅}̅≥2%, giving an output value by the controller through the PID control algorithm in step 6), and transmitting the signals (temperature signal Tᵢ, the pressure signal Pᵢ and the flow velocity signal Vᵢ) to the adjustment valve through the RS485 bus to adjust the valve opening degree to alter a water injection amount to flush away a crystallized ammonium salt; and repeatedly performing step 2) to step 6) at a same time, until e̅_̅{̅X̅(̅i̅)̅}̅<2%, the output of the console is zero, and the opening degree of the adjustment valve remains unchanged.

The present invention has the following advantages: temperature, pressure and flow velocity signals of the inlet and outlet pipes of heat exchange devices are monitored; a console performs analysis the error of the three signals; a PID control algorithm is used to control the adjustment valve to alter the valve opening degree to adjust the water injection amount in real time, which alleviates the problem of ammonium salt corrosion failures in hydrogenation apparatuses of petrochemical enterprises and conforms to the concepts of energy conservation and environmental protection.

The present invention is suitable for hydrogenation apparatuses in fields such as petrochemical engineering, has simple processes and strong applicability, is convenient to refit, and can be applied to hydrogenation processes having different numbers of heat exchange devices.

### BRIEF DESCRIPTION OF THE DRAWINGS

FIG. 1 is a structural diagram of a PID control-based adaptive intelligent water injection system.

In FIG. 1: 1. water injection portion, 2. power portion, 3. control portion, 4. measurement and transmission portion, 5. motor, 6. water pump, 7. console, 8. adjustment valve, 9. temperature transmitter (TT), 10. pressure transmitter (PT), 11. flow velocity transmitter (FT), 12. heat exchanger, 13. air cooler, 14. straight pipe, 15. separation tank, 16. hydrogenation reactor, 17. RS485 bus, 18. oil phase, 19. gas phase, and 20. acidic aqueous phase.

FIG. 2 is a block diagram of program control of the PID control-based adaptive intelligent water injection system.

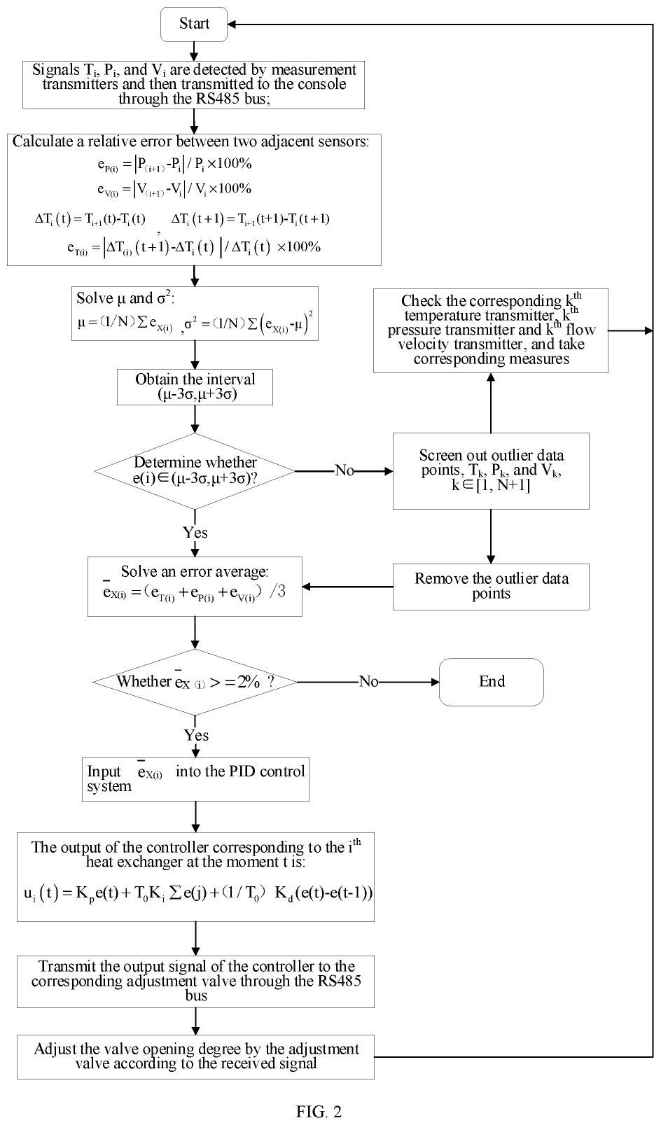

In FIG. 2, the temperature signal Tᵢ, the pressure signal Pᵢ and the flow velocity signal Vᵢ are detected by measurement transmitters and then transmitted to the console through the RS485 bus; the console performs error analysis on the three sets of signals to calculate an average error e_{X(i)} of each set of signals, and determines whether there are outlier data points according to Gaussian distribution and the principle of 3^{σ}; if there are outlier data points, the k^{th} temperature transmitter, k^{th} pressure transmitter and k^{th} flow velocity transmitter are checked, and measures, such as maintenance or replacement, are taken. When there are no outlier data points, or there are outlier data points but the outlier data points are removed, an average error e̅_̅{̅X̅(̅i̅)̅}̅ is calculated, and it is determined whether the average error is greater than or equal to 2%. If yes, the average error e̅_̅{̅X̅(̅i̅)̅}̅ is inputted to a PID control system to obtain an opening degree required by an adjustment valve through a PID control algorithm, and an output signal is transmitted to the adjustment valve. The adjustment valve alters the valve opening degree to adjust the water injection amount. The above process is repeatedly performed until e̅_̅{̅X̅(̅i̅)̅}̅<2% is satisfied, the output of the control system is zero, and the opening degree of the adjustment valve no longer alters.

### DETAILED DESCRIPTION OF THE EMBODIMENTS

The present invention is further described below with reference to the drawings and embodiments.

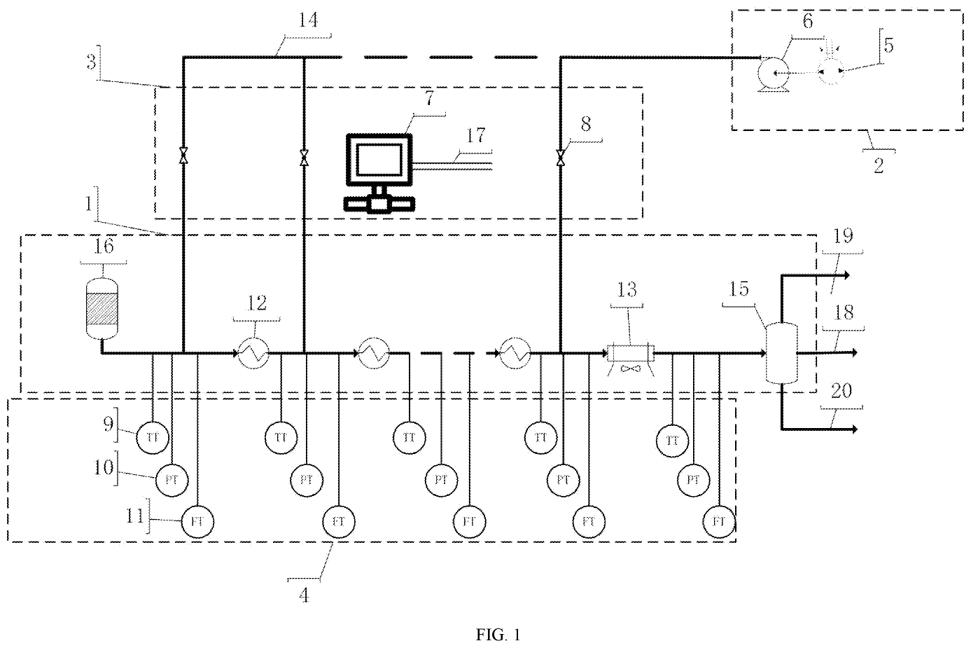

As shown in FIG. 1, the present invention includes the water injection portion 1, the power portion 2, the control portion 3, and the measurement and transmission portion 4.

The water injection portion 1 includes the hydrogenation reactor 16, N shell-and-tube heat exchangers 12, air coolers 13, and the separation tank 15. A hydrogenation reaction effluent at the bottom of the hydrogenation reactor 16 is connected to inlets of the air coolers 13 via the N shell-and-tube heat exchangers 12. Hydrogenation reaction effluent is cooled by a plurality of parallel air coolers 13, and then is connected to an inlet located on a side surface of the separation tank 15 through an outlet manifold of the air coolers 13. The hydrogenation reaction effluent is separated into an oil phase 18, a gas phase 19, and an acidic aqueous phase 20 by the separation tank 15, wherein the gas phase 19 flows out of the top of the separation tank 15, the oil phase 18 flows out of the side surface of the separation tank 15 corresponding to the inlet, and the acidic aqueous phase 20 flows out of the bottom of the separation tank 15. N−1 pipelines are separately led out from pipes between the N shell-and-tube heat exchangers, one pipeline is led out from an inlet pipe of the first heat exchanger, one pipeline is led out from a pipe between the last heat exchanger and the air coolers 13, and a total of N+1 pipelines constitute parallel pipes. Branches of the parallel pipes are throttled by N+1 adjustment valves 8 of an identical specification, respectively, and then are gathered to the straight pipe 14. One end of each adjustment valve 8 is connected to a main pipeline of the hydrogenation reaction effluent through a three-way pipe, and the other end of each adjustment valve 8 is connected to the straight pipe 14 through an elbow or three-way pipe. The straight pipe 14 is connected to the power portion 2. The temperature transmitter 9, the pressure transmitter 10 and the flow velocity transmitter 11 are connected to each of an inlet pipeline and an outlet pipeline of each of the shell-and-tube heat exchangers 12 to jointly form the measurement and transmission portion 4. Signals of the three transmitters are connected to the control portion 3 to control an opening degree required by each adjustment valve 8.

The power portion 2 includes the motor 5 and the water pump 6. The motor 5 drives the water pump 6 to rotate, and an outlet of the water pump 6 is connected to an inlet of the straight pipe 14.

The control portion 3 includes the console 7 and the RS485 bus 17. The signals of the three transmitters are transmitted to the console 7 through the RS485 bus 17 to control the opening degree required by each adjustment valves 8 through a PID control algorithm.

The N shell-and-tube heat exchangers 12 are set according to an actual requirement of an industrial site.

As shown in FIG. 2, the water injection method includes following steps.

Step 1): after the stable operation of the system, the hydrogenation reaction effluent successively passes through N heat exchangers 12 (four heat exchangers is used in the figure) and a plurality of parallel air coolers 13 from the bottom of the hydrogenation reactor 17 and then enters the separation tank 15.

Step 2): the temperature transmitter 9, the pressure transmitter 10, and the flow velocity transmitter 11 are arranged at each of an inlet and an outlet of each of N heat exchangers 12 connected in series, and the total number of each of the three transmitters is N+1. The three transmitters detect and transmit the temperature signal Tᵢ, the pressure signal Pᵢ and the flow velocity signal Vᵢ to the console 7 through the RS485 bus, respectively, wherein a value range of i is i∈[1, N+1].

Step 3): the console 7 receives the temperature signal Tᵢ, the pressure signal Pᵢ and the flow velocity signal Vᵢ, and then performs screening analysis as follows on the signals.

Under a normal working condition, a temperature difference between two ends of the heat exchanger or the air coolers basically remains constant, that is, no salt coagulation occurs in the heat exchanger. Therefore, a relative error of temperature values of two adjacent heat exchangers cannot be directly calculated, but the following calculation method is employed: at the moment t and the moment t+1, the temperature differences detected by any two adjacent temperature transmitters are ΔT₍ᵢ₎(t) and ΔT₍ᵢ₎(t+1), respectively, wherein

ΔT₍ᵢ₎(t)=|T₍ᵢ₊₁₎(t)−T₍ᵢ₎(t)|

ΔT₍ᵢ₎(t+1)=|T₍ᵢ₊₁₎(t+1)−T₍ᵢ₎(t+1)|,

where signals monitored by the i^{th} temperature transmitter and the i+1^{th} temperature transmitter at the moment t are T₍ᵢ₎(t) and T₍ᵢ₊₁₎(t), respectively; similarly, signals monitored by the i^{th} temperature transmitter and the i+1^{th} temperature transmitter at the moment t+1 are T₍ᵢ₎(t+1) and T₍ᵢ₊₁₎(t+1), respectively.

Then, a temperature signal relative error between two adjacent temperature transmitters is e_{T(i)}:

$${e}_{T ( i )} = \frac{\vert Δ {T}_{( i )} ( t + 1 ) - Δ {T}_{( i )} ( t ) \vert}{Δ {T}_{( i )} ( t )} \times 100 \% ;$$

a pressure signal relative error between any two adjacent pressure transmitters is e_{P(i)}:

$${e}_{P ( i )} = \frac{\vert {P}_{i + 1} - {P}_{i} \vert}{{P}_{i}} \times 100 \% ;$$

and

similarly, a flow velocity signal relative error between any two adjacent flow velocity transmitters is e_{V(i)}:

$${e}_{V ( i )} = \frac{\vert {V}_{i + 1} - {V}_{i} \vert}{{V}_{i}} \times 100 \% .$$

Assuming that the relative error e_{X(i)} follows Gaussian distribution E-N(μ, σ²), where X takes the pressure P, the temperature T or the flow velocity V, then a probability density function of the relative error e_{X(i)} is:

$$p ( E ) = \frac{1}{\sqrt{2 π} σ} exp ( \frac{- {( {e}_{X ( i )} - μ )}^{2}}{2 {σ}^{2}} ) ,$$

where μ is an overall expectation, and σ² is a population variance.

μ and σ² in a population are predicted according to an existing relative error e_{X(i)}, and a calculation method is as follows:

$$μ = \frac{1}{N} {\sum }_{i = 1}^{N} {e}_{X ( i )} , \\ {σ}^{2} = \frac{1}{N} {\sum }_{i = 1}^{N} {( {e}_{X ( i )} - μ )}^{2} .$$

Step 4): according to the principle of 3σ that the probability of e_{X(i)}, falling outside (μ−3σ, μ+3σ) is less than 3‰, the interval (μ−3σ, μ+3σ) is taken as an actual possible value interval of the relative error e_{X(i)}, and data outside the value interval is taken as outlier data and thus are removed. If there is no outlier data, the method goes directly to step 5); otherwise, outlier data points are screened out to be Tₖ, Pₖ, and Vₖ, where k∈[1, N+1], and then the k^{th} temperature transmitter, k^{th} pressure transmitter and k^{th} flow velocity transmitter are checked and replaced in time.

Step 5): an average value e̅_̅{̅X̅(̅i̅)̅}̅ of the three relative errors e_{T(i)}, e_{P(i)}, and e_{V(i)} at any position is calculated as follows:

$$\overline{{e}_{X ( i )}} = \frac{\vert {e}_{T ( i )} + {e}_{P ( i )} + {e}_{V ( i )} \vert}{3} \times 100 \% ,$$

if e̅_̅{̅X̅(̅i̅)̅}̅≤1%, then no salt coagulation and blockage occur in the i^{th} heat exchanger and an inlet pipe and an outlet pipe of the i^{th} heat exchanger;

if 1%<e̅_̅{̅X̅(̅i̅)̅}̅2%, then slight salt coagulation occurs in the i^{th} heat exchanger and the inlet pipe and the outlet pipe of the i^{th} heat exchanger, and it is unnecessary to take measures; and

if e̅_̅{̅X̅(̅i̅)̅}̅≥2%, then it is considered that salt coagulation occurs in the i^{th} heat exchanger and the inlet pipe and the outlet pipe of the i^{th} heat exchanger, and the console is required to issue an instruction to the Q^{th} adjustment valve, Q∈[1, N], to enable the Q^{th} adjustment valve to adjust a valve opening degree in real time.

Step 6): the console 7 employs the PID control algorithm, including a proportional (P) control parameter, an integral (I) control parameter and a differential (D) control parameter. The average error e̅_̅{̅X̅(̅i̅)̅}̅ is taken as the input of the whole control system, and a difference e(t) between the average error e̅_̅{̅X̅(̅i̅)̅}̅ and a set value e₀ is taken as the input of a controller;

wherein e₀=2%, and

an opening degree of the adjustment valve at the moment t is taken as the output uᵢ(t) of the controller and is expressed by the following formula:

$${u}_{i} ( t ) = {K}_{p} e ( t ) + {T}_{0} {K}_{i} {\sum }_{j = 0}^{t} e ( j ) + \frac{1}{{T}_{0}} {K}_{d} ( e ( t ) - e ( t - 1 ) ) ,$$

where Kₚ, Kᵢ, and K_{d} represent a proportional coefficient, an integral time constant, and a differential time constant, respectively, and T₀ is a sampling cycle of each transmitter. The system is adjusted and controlled to meet predetermined requirements.

Step 7): in step 5), if e̅_̅{̅X̅(̅i̅)̅}̅≥2%, the controller gives an output value through the PID control algorithm in step 6), and the signals are transmitted to the adjustment valve 8 through the RS485 bus 17 to adjust the valve opening degree to alter the water injection amount to flush away the crystallized ammonium salt; and step 2) to step 6) are repeatedly performed at the same time, until e̅_̅{̅X̅(̅i̅)̅}̅<2%, the output of the console 7 is zero, and the opening degree of the adjustment valve remains unchanged.

Taking a process of a 3# diesel hydrogenation apparatus in a petrochemical enterprise as an example, the heat exchanger is a shell-and-tube heat exchanger; the specification of tube bundles of the air cooler is Φ25 mm×3 mm×10000 mm, and the material is carbon steel. According to analysis data of a laboratory information management system (LIMS), in the crude oil of the diesel hydrogenation apparatus, the content of sulfur is 6195.2 mg/kg, the content of chlorine is less than 0.5 mg/kg, and the content of nitrogen is 512.8 mg/kg. Temperature, pressure, and flow velocity signal data collected from a distributed control system (DCS) is as follows:

There are four heat exchangers in the apparatus, and a temperature signal of two adjacent heat exchangers is:

Moment t:

| T₁(t) | T₂(t) | T₃(t) | T₄(t) | T₅(t) |
|---|---|---|---|---|
| 378.22° C. | 271.55° C. | 196.95° C. | 164.69° C. | 102.64° C. |

ΔT₍₁₎(t)=106.67, ΔT₍₂₎(t)=74.6, ΔT₍₃₎(t)=32.26, ΔT₍₄₎(t)=62.05.

Moment t+1:

| T₁(t + 1) | T₂(t + 1) | T₃(t + 1) | T₄(t + 1) | T₅(t + 1) |
|---|---|---|---|---|
| 378.21° C. | 271.55° C. | 195.25° C. | 163.00° C. | 100.92° C. |

ΔT₍₁₎(t+1)=106.66, ΔT₍₂₎(t+1)=76.3, ΔT₍₃₎(t+1)=32.25, ΔT₍₄₎(t+1)=62.08.

A relative error is:

$${e}_{T ( 1 )} = \frac{\vert Δ {T}_{( 1 )} ( t + 1 ) - Δ {T}_{( 1 )} ( t ) \vert}{Δ {T}_{( 1 )} ( t )} \times 100 \% = \frac{\vert 106.66 - 106.67 \vert}{106.66} \times 100 \% = 0.0094 \% .$$

Similarly, e_{T(2)}(t)=2.28%, e_{T(3)}(t)=0.03%, and e_{T(4)}(t)=0.05%.

A pressure signal of two adjacent heat exchangers is:

| P₁ | P₂ | P₃ | P₄ | P₅ |
|---|---|---|---|---|
| 6.56 MPa | 6.55 MPa | 6.71 MPa | 6.70 MPa | 6.72 MPa |

A relative error is:

$${e}_{P ( 1 )} = \frac{\vert {P}_{2} - {P}_{1} \vert}{{P}_{1}} \times 100 \% = \frac{\vert 6.55 - 6.56 \vert}{6.56} \times 100 \% = 0.15 \% .$$

Similarly, e_{P(2)}=2.44%, e_{P(3)}=0.15%, and e_{P(4)}=0.15%.

A flow velocity signal of two adjacent heat exchangers is:

| V₁ | V₂ | V₃ | V₄ | V₅ |
|---|---|---|---|---|
| 155.426 t/h | 155.429 t/h | 155.051 t/h | 155.055 t/h | 155.050 t/h |

A relative error is:

$${e}_{V ( 1 )} = \frac{\vert {V}_{2} - {V}_{1} \vert}{{V}_{1}} \times 100 \% = \frac{\vert 155.429 - 155.426 \vert}{155.426} \times 100 \% = 0.002 \% .$$

Similarly, e_{V(2)}=2.43%, e_{V(3)}=0.0026%, and e_{V(1)}=0.003%.

An average error of e_{T(i)}, e_{P(i)}, and e_{V(i)} is:

$$\overline{{e}_{X ( 1 )}} = \frac{\vert {e}_{T ( 1 )} + {e}_{P ( 1 )} + {e}_{V ( 1 )} \vert}{3} \times 100 \% = \frac{0.0094 \% + 0.15 \% + 0.002 \%}{3} = 0.1614 \% < 1 \% .$$

Similarly, e̅_̅{̅X̅(̅2̅)̅}̅=2.3833%>2%, e̅_̅{̅X̅(̅3̅)̅}̅=0.0609%<1%, and e̅_̅{̅X̅(̅4̅)̅}̅=0.0677%<1%.

Taking the temperature as an example, the relative error e_{T(i)} follows Gaussian distribution E-N(μ, σ²),

$$μ = \frac{1}{4} {\sum }_{i = 1}^{4} {e}_{X ( i )} = 0.5935 \% , \\ {σ}^{2} = \frac{1}{4} {\sum }_{i = 1}^{4} {( {e}_{X ( i )} - μ )}^{2} = 0.0127 \% .$$

A probability density function thereof is:

$$p ( E ) = \frac{1}{\sqrt{2 π} σ} exp ( \frac{- {( {e}_{X ( i )} - μ )}^{2}}{2 {σ}^{2}} ) = \frac{1}{2.8137 \%} exp ( \frac{- {( {e}_{X ( i )} - 0.5935 \% )}^{2}}{0.02532} ) .$$

The interval (μ−3σ, μ+3σ) is (−2.7873%, 3.9743%).

As can be seen, data of e_{T(1)}, e_{T(2)}, e_{T(3)}, and e_{T(4)} are all in the interval, that is, there is no outlier data. Assuming that data e_{X(k)} in e_{X(i)} is not in the interval (μ−3σ, μ+3σ), it is considered that the relative error e_{X(k)} is caused by a system error and thus a field operator is required to repair or replace the k^{th} temperature transmitter.

Upon analysis on the average error e̅_̅{̅X̅(̅i̅)̅}̅ it is obvious that there is no salt coagulation in the first, third, and fourth heat exchangers and inlet and outlet pipes thereof, and there is salt coagulation in the second heat exchanger and inlet and outlet pipelines thereof. Therefore, the console is required to issue an instruction to the second adjustment valve to alter the water injection amount by adjusting the valve opening degree.

e(t)=2.2833%−2%=0.2833% is inputted to the controller,

$${u}_{i} ( t ) = {K}_{p} e ( t ) + {T}_{0} {K}_{i} {\sum }_{j = 0}^{t} e ( j ) + \frac{1}{{T}_{0}} {K}_{d} ( e ( t ) - e ( t - 1 ) ) .$$

In engineering application, PID parameters are generally determined by an empirical method. That is, for different process control systems, an engineer needs to, according to actual working conditions and process characteristics, first use pure proportional control, namely only set a parameter Kₚ, and adjust Kₚ to enable the output of the controller to quickly achieve and maintain a stable value, and then appropriately add integral and differential actions, namely set parameters Kᵢ and K_{d}, to make the adjustment time (i.e., the time required for the system response to reach and remain within ±5% of termination) of the control system as short as possible. The stable value outputted by the controller is the opening degree of the adjustment valve. The console transmits a signal to the adjustment valve through the RS485 bus to alter the water injection amount by adjusting the valve opening degree, until e̅_̅{̅X̅(̅i̅)̅}̅<2%, the output of the console is zero, and the valve opening degree no longer alters.

### Embodiment 2

The structural composition of a system of the present embodiment is the same as that in Embodiment 1, except that the material of the air cooler is different from that in Embodiment 1. The intelligent water injection method in the present invention is also applicable to the system. The specification of tube bundles of the air cooler is Φ25 mm×3 mm×10000 mm, and the material is Incoloy 825.

Taking a process of a hydrocracking apparatus in a petrochemical enterprise as an example, as can be seen, according to analysis data of an LIMS system, in crude oil of a diesel hydrogenation apparatus, the content of sulfur is 21863.5 mg/kg, the content of chlorine is less than 0.5 mg/kg, and the content of nitrogen is 632.5 mg/kg, which belongs to typical high-sulfur crude oil. Temperature, pressure, and flow velocity signal data collected from a DCS is as follows:

There are four heat exchangers in the apparatus, and a temperature signal of two adjacent heat exchangers is:

Moment t:

| T₁(t) | T₂(t) | T₃(t) | T₄(t) | T₅(t) |
|---|---|---|---|---|
| 382.31° C. | 275.51° C. | 190.81° C. | 152.69° C. | 103.49° C. |

ΔT₍₁₎(t)=106.80, ΔT₍₂₎(t)=84.70, ΔT₍₃₎(t)=38.12, ΔT₍₄₎(t)=49.20.

Moment t+1:

| T₁(t + 1) | T₂(t + 1) | T₃(t + 1) | T₄(t + 1) | T₅(t + 1) |
|---|---|---|---|---|
| 382.52° C. | 275.59° C. | 191.98° C. | 153.42° C. | 105.37° C. |

ΔT₍₁₎(t+1)=106.93, ΔT₍₂₎(t+1)=83.61, ΔT₍₃₎(t+1)=38.56, ΔT₍₄₎(t+1)=48.05.

A relative error is:

$${e}_{T ( 1 )} = \frac{\vert Δ {T}_{( 1 )} ( t + 1 ) - Δ {T}_{( 1 )} ( t ) \vert}{Δ {T}_{( 1 )} ( t )} \times 100 \% = \frac{\vert 106.93 - 106.80 \vert}{106.80} \times 100 \% = 0.11 \% .$$

Similarly, e_{T(2)}(t)=1.28%, e_{T(3)}(t)=1.15%, and e_{T(4)}(t)=2.34%.

A pressure signal of two adjacent heat exchangers is:

| P₁ | P₂ | P₃ | P₄ | P₅ |
|---|---|---|---|---|
| 7.89 MPa | 7.88 MPa | 7.77 MPa | 7.69 MPa | 7.51 MPa |

A relative error is:

$${e}_{P ( 1 )} = \frac{\vert {P}_{2} - {P}_{1} \vert}{{P}_{1}} \times 100 \% = \frac{\vert 7.88 - 7.89 \vert}{7.89} \times 100 \% = 0.13 \% .$$

Similarly, e_{P(2)}=1.40%, e_{P(3)}=1.02%, and e_{P(4)}=2.34%.

A flow velocity signal of two adjacent heat exchangers is:

| V₁ | V₂ | V₃ | V₄ | V₅ |
|---|---|---|---|---|
| 142.69 t/h | 144.06 t/h | 145.75 t/h | 146.97 t/h | 149.88 t/h |

A relative error is:

$${e}_{V ( 1 )} = \frac{\vert {V}_{2} - {V}_{1} \vert}{{V}_{1}} \times 100 \% = \frac{\vert 142.69 - 144.06 \vert}{144.06} \times 100 \% = 0.96 \% .$$

Similarly, e_{V(2)}=1.17%, e_{V(3)}=0.84%, and e_{V(4)}=1.98%.

Then, an average error of e_{T(i)}, e_{P(i)}, and e_{V(i)} is:

$$\overline{{e}_{X ( 1 )}} = \frac{\vert {e}_{T ( 1 )} + {e}_{P ( 1 )} + {e}_{V ( 1 )} \vert}{3} \times 100 \% = \frac{0.11 \% + 0.13 \% + 0.96 \%}{3} = 0.4 \% < 1 \% .$$

Similarly, e̅_̅{̅X̅(̅2̅)̅}̅=1.28%<2%, e̅_̅{̅X̅(̅3̅)̅}̅=1.00%<2%, and e̅_̅{̅X̅(̅4̅)̅}̅=2.22%>2%.

By adopting the same method as that in Embodiment 1, it can be seen that data of e_{T(1)}, e_{T(2)}, e_{T(3)}, and e_{T(4)} are all in the interval (μ−3σ, μ+3σ), that is, there is no outlier data.

Upon analysis on the average error e̅_̅{̅X̅(̅i̅)̅}̅, it is obvious that there is no salt coagulation in the first heat exchanger and inlet and outlet pipes thereof; there is slight salt coagulation in the second and third heat exchangers and inlet and outlet pipes thereof, and the valve opening degree remains the same as that of the previous moment, there is salt coagulation in the fourth heat exchanger and inlet and outlet pipes thereof, and the console is required to issue an instruction to the fourth adjustment valve to alter the water injection amount by adjusting the valve opening degree.

e(t)=2.22%−2%=0.22% is inputted to the controller,

$${u}_{i} ( t ) = {K}_{p} e ( t ) + {T}_{0} {K}_{i} {\sum }_{j = 0}^{t} e ( j ) + \frac{1}{{T}_{0}} {K}_{d} ( e ( t ) - e ( t - 1 ) ) .$$

Kₚ, Kᵢ, and K_{d} are determined by the same PID parameter setting method as that in Embodiment 1. Through the PID control algorithm, the control system outputs an instruction, the console transmits a signal to the adjustment valve through the RS485 bus to alter the water injection amount by adjusting the valve opening degree, until e̅_̅{̅X̅(̅i̅)̅}̅<2%, the output of the console is zero, and the valve opening degree no longer alters.

Large general simulation process system Aspen Plus software, is employed to calculate the water injection required to ensure 25% liquid water at different temperatures. Assuming that the water injection amount is 100 t/h when a valve is fully opened, and the water injection amount is 32 tons when an inlet temperature of the heat exchanger is 194.7° C., in this case, the controller outputs uᵢ(t)=0.32, then the valve adjusts the opening degree to 32% according to an instruction of the console, that is, the water injection amount is 32 t/h. In the process of water injection, measurement transmitters continue to transmit signals to the console, the average error e̅_̅{̅X̅(̅i̅)̅}̅ gradually decreases, the valve opening degree also gradually decreases. When e̅_̅{̅X̅(̅i̅)̅}̅ <2%, it is considered that the amount of the crystallized ammonium salt in the heat exchanger already reaches an expected value, the output of the controller output is zero, and the valve opening degree remains the opening value of the previous moment.

From the above experimental results, it can be seen that the present invention achieves a certain application effect in the hydrogenation process. The added measurement transmitters can be directly integrated into DCS, and data acquired through DCS is accurate and fast. The console only needs to extract such three sets of data of temperature, pressure, and flow velocity, and perform screening and error analysis on the three sets of data to determine whether the average error satisfies the condition of e̅_̅{̅X̅(̅i̅)̅}̅ >2%. If yes, the controller issues an instruction to the adjustment valve through the PID control algorithm according to the average error. The adjustment valve receives the instruction and then alters an opening degree to adjust the water injection amount, so as to wash the crystallized ammonium salt, thereby achieving an effect of adaptive adjustment and effectively reducing the risk of flow corrosion failures of heat exchange devices.

At present, the water injection process is widely used in the hydrogenation process, which indeed alleviates the problem of corrosion caused by the crystallized ammonium salt to some extent. The quality of the crude oil, however, is becoming increasingly poor, the traditional water injection technology has gradually lost advantages and has increasingly worse effect, which aggravates the waste of water resources and energy consumption in turn. The PID control-based adaptive intelligent water injection system according to the present invention is simple in structure, convenient to refit, and quite flexible, and has wide applicability, which not only solves the risk of flow corrosion failures of the hydrogenation apparatus caused by the lag in the traditional water injection process, but also saves water resources and brings certain economic benefits to enterprises.

What is claimed is:

1. A water injection method for a PID control-based adaptive intelligent water injection system, wherein, the PID control-based adaptive intelligent water injection system comprises a water injection portion, a power portion, a control portion, and a measurement and transmission portion;
the water injection portion comprises a hydrogenation reactor, N shell-and-tube heat exchangers, a plurality of parallel air coolers, and a separation tank; wherein
a hydrogenation reaction effluent at a bottom of the hydrogenation reactor is connected to inlets of the plurality of parallel air coolers via the N shell-and-tube heat exchangers;
the hydrogenation reaction effluent is cooled by the plurality of parallel air coolers, and then the hydrogenation reaction effluent is connected to an inlet located on a side surface of the separation tank through an outlet manifold of the plurality of parallel air coolers;
the hydrogenation reaction effluent is separated into a gas phase, an oil phase and an acidic aqueous phase by the separation tank, wherein the gas phase flows out of a top of the separation tank, the oil phase flows out of the side surface of the separation tank corresponding to the inlet, and the acidic aqueous phase flows out of a bottom of the separation tank;
N−1 pipelines are separately led out from pipes between the N shell-and-tube heat exchangers, a first external pipeline in front of an inlet pipe of a first shell-and-tube heat exchanger of the N shell-and-tube heat exchangers is led out from the inlet pipe of the first shell-and-tube heat exchanger, and a second external pipeline between a last shell-and-tube heat exchanger of the N shell-and-tube heat exchangers and the plurality of parallel air coolers is led out from a pipe between the last shell-and-tube heat exchanger and the plurality of parallel air coolers, and a total of N+1 pipelines constitute parallel pipes;
branches of the parallel pipes are throttled by N+1 adjustment valves of an identical specification, respectively, and then the branches of the parallel pipes are gathered to a straight pipe to connect to the power portion;
a temperature transmitter, a pressure transmitter, and a flow velocity transmitter are connected to each of an inlet pipeline and an outlet pipeline of each shell-and-tube heat exchanger of the N shell-and-tube heat exchangers to jointly form the measurement and transmission portion; and
a temperature signal Tᵢ of the temperature transmitter, a pressure signal Pᵢ of the pressure transmitter and a flow velocity signal Vᵢ of the flow velocity transmitter are connected to the control portion to control an opening degree required by each adjustment valve of the N+1 adjustment valves;
the power portion comprises a motor and a water pump; wherein the motor drives the water pump to rotate, and an outlet of the water pump is connected to an inlet of the straight pipe; and
the control portion comprises a console and an RS485 bus; wherein the temperature signal Tᵢ, the pressure signal Pᵢ and the flow velocity signal Vᵢ are transmitted to the console through the RS485 bus to control the opening degree required by the each adjustment valve through a PID control algorithm;
the water injection method comprises the following steps:
step 1): after a stable operation of the PID control-based adaptive intelligent water injection system, enabling the hydrogenation reaction effluent to successively pass through the N shell-and-tube heat exchangers and the plurality of parallel air coolers from the bottom of the hydrogenation reactor and then to enter the separation tank;
step 2): arranging the temperature transmitter, the pressure transmitter, and the flow velocity transmitter at each of the inlet pipeline and the outlet pipeline of the each shell-and-tube heat exchanger of the N shell-and-tube heat exchangers connected in series, wherein a total number of each of the temperature transmitter, the pressure transmitter and the flow velocity transmitter is N+1; detecting and transmitting, by the temperature transmitter, the pressure transmitter and the flow velocity transmitter, the temperature signal Tᵢ, the pressure signal Pᵢ, and the flow velocity signal Vᵢ to the console through the RS485 bus, respectively, wherein a value range of i is i∈[1, N+1];
step 3): receiving, by the console, the temperature signal Tᵢ, the pressure signal Pᵢ and the flow velocity signal Vᵢ, and then performing screening analysis on the temperature signal Tᵢ, the pressure signal Pᵢ and the flow velocity signal Vᵢ, wherein the screening analysis is as follows:
under a normal working condition, a temperature difference between two ends of the each shell-and-tube heat exchanger or two ends of the plurality of parallel air coolers basically remains constant, and no salt coagulation occurs in the each shell-and-tube heat exchanger; therefore, a relative error of temperature values of two adjacent shell-and-tube heat exchangers of the N shell-and-tube heat exchangers are calculated by the following calculation method: at a moment t and a moment t+1, temperature differences detected by any two adjacent temperature transmitters are ΔT₍ᵢ₎(t) and ΔT₍ᵢ₎(t+1), respectively, wherein
ΔT₍ᵢ₎(t)=|T₍ᵢ₊₁₎(t)−T₍ᵢ₎(t)|

ΔT₍ᵢ₎(t+1)=|T₍ᵢ₊₁₎(t+1)−T₍ᵢ₎(t+1)|,
where signals monitored by an i^{th} temperature transmitter and an i+1^{th} temperature transmitter at the moment t are T₍ᵢ₎(t) and T₍ᵢ₊₁₎(t), respectively; signals monitored by the i^{th} temperature transmitter and the i+1^{th} temperature transmitter at the moment t+1 are T₍ᵢ₎(t+1) and T₍ᵢ₊₁₎(t+1), respectively;
then, a temperature signal relative error between two adjacent temperature transmitters is e_{T(i)}:
$${e}_{T ( i )} = \frac{\vert Δ {T}_{( i )} ( t + 1 ) - Δ {T}_{( i )} ( t ) \vert}{Δ {T}_{( i )} ( t )} \times 100 \% ;$$
a pressure signal relative error between any two adjacent pressure transmitters is e_{P(i)}:
$${e}_{P ( i )} = \frac{\vert {P}_{i + 1} - {P}_{i} \vert}{{P}_{i}} \times 100 \% ;$$
a flow velocity signal relative error between any two adjacent flow velocity transmitters is e_{V(i)}:
$${e}_{V ( i )} = \frac{\vert {V}_{i + 1} - {V}_{i} \vert}{{V}_{i}} \times 100 \% ;$$
assuming that a relative error e_{X(i)} follows a Gaussian distribution E-N(μ, σ²), where X takes a pressure P, a temperature T or a flow velocity V, then a probability density function of the relative error e_{X(i)} is:
$$p ( E ) = \frac{1}{\sqrt{2 π} σ} exp ( \frac{- {( {e}_{X ( i )} - μ )}^{2}}{2 {σ}^{2}} ) ,$$
where μ is an overall expectation, and σ² is a population variance;
μ and σ² in a population are predicted according to the relative error e_{X(i)}, and a calculation method for μ and σ² is as follows:
$$μ = \frac{1}{N} {\sum }_{i = 1}^{N} {e}_{X ( i )} , \\ {σ}^{2} = \frac{1}{N} {\sum }_{i = 1}^{N} {( {e}_{X ( i )} - μ )}^{2} ;$$
step 4): according to a principle of 3σ that a probability of e_{X(i)} falling outside (μ−3σ, μ+3σ) is less than 3‰, taking an interval (μ−3σ, μ+3σ) as an actual possible value interval of the relative error e_{X(i)}, taking data outside the actual possible value interval as outlier data, and removing the outlier data; when no outlier data exist, going to step 5); when the outlier data exist, screening out outlier data points to be Tₖ, Pₖ, and Vₖ, where k∈[1, N+1], and then checking and replacing a k^{th} temperature transmitter, a k^{th} pressure transmitter and a k^{th} flow velocity transmitter in time;
step 5): calculating an average error e̅_̅{̅X̅(̅i̅)̅}̅ of the temperature signal relative error e_{T(i)}, the pressure signal relative error e_{P(i)}, and the flow velocity signal relative error e_{V(i)} at any position as follows:
$$\overline{{e}_{X ( i )}} = \frac{\vert {e}_{T ( i )} + {e}_{P ( i )} + {e}_{V ( i )} \vert}{3} \times 100 \% ,$$
wherein, when e̅_̅{̅X̅(̅i̅)̅}̅≤1%, then no salt coagulation and blockage occurs in an i^{th} shell-and-tube heat exchanger of the N shell-and-tube heat exchangers and an inlet pipe and an outlet pipe of the i^{th} shell-and-tube heat exchanger;
when 1%<e̅_̅{̅X̅(̅i̅)̅}̅<2%, then slight salt coagulation occurs in the i^{th} shell-and-tube heat exchanger and the inlet pipe and the outlet pipe of the i^{th} shell-and-tube heat exchanger, and it is unnecessary to take measures; and
when e̅_̅{̅X̅(̅i̅)̅}̅≥2%, then salt coagulation occurs in the i^{th} shell-and-tube heat exchanger and the inlet pipe and the outlet pipe of the i^{th} shell-and-tube heat exchanger, and the console is required to issue an instruction to a Q^{th} adjustment valve of the N+1 adjustment valves, Q∈[1, N], to enable the Q^{th} adjustment valve to adjust the opening degree in real time;
step 6): employing, by the console, the PID control algorithm comprising a proportional control parameter, an integral control parameter and a differential control parameter; taking the average error e̅_̅{̅X̅(̅i̅)̅}̅ as an input of the PID control-based adaptive intelligent water injection system, and taking a difference e(t) between the average error e̅_̅{̅X̅(̅i̅)̅}̅ and a set value e₀ as an input of a controller; wherein e₀=2%; and taking the opening degree of the Q^{th} adjustment valve at the moment t as an output uᵢ(t) of the controller, wherein the output uᵢ(t) is expressed by the following formula:
$${u}_{i} ( t ) = {K}_{p} e ( t ) + {T}_{0} {K}_{i} {\sum }_{j = 0}^{t} e ( j ) + \frac{1}{{T}_{0}} {K}_{d} ( e ( t ) - e ( t - 1 ) ) ,$$
where Kₚ, Kᵢ, and K_{d} represent a proportional coefficient, an integral time constant, and a differential time constant, respectively, and T₀ is a sampling cycle of each transmitter of the temperature transmitter, the pressure transmitter and the flow velocity transmitter; adjusting and controlling the PID control-based adaptive intelligent water injection system to meet predetermined requirements;
step 7): in step 5), when e̅_̅{̅X̅(̅i̅)̅}̅≥2%, giving a output value corresponding to e̅_̅{̅X̅(̅i̅)̅}̅≥2% by the controller through the PID control algorithm in step 6), and transmitting the temperature signal Tᵢ, the pressure signal Pᵢ and the flow velocity signal Vᵢ to an adjustment valve corresponding to e̅_̅{̅X̅(̅i̅)̅}̅≥2% through the RS485 bus to adjust the opening degree of the adjustment valve to alter a water injection amount to flush away a crystallized ammonium salt; and repeatedly performing step 2) to step 6) at a same time, until e̅_̅{̅X̅(̅i̅)̅}̅<2%, an output of the console is zero, and the opening degree of the adjustment valve remains unchanged.
